(19) United States
(12) Patent Application Publication
(10) Pub. No.: US 2013/0342953 A1
(43) Pub. Date: Dec. 26, 2013

(54) HIGH VOLTAGE NON-COPLANAR INTERDIGITATED VARACTOR

(71) Applicant: University of Dayton, Dayton, OH (US)

(72) Inventor: Guru Subramanyam, Dayton, OH (US)

(21) Appl. No.: 13/923,251

(22) Filed: Jun. 20, 2013

Related U.S. Application Data
(60) Provisional application No. 61/661,894, filed on Jun. 20, 2012.

(51) Int. Cl. H01G 5/01

(52) U.S. Cl. CPC H01G 5/01
USPC 361/277

(57) ABSTRACT

A high voltage varactor that provides a large tuning ratio and a high DC biasing capability includes a non-coplanar interdigitated structure having a stacked structure with a plurality of substantially parallel coplanar first electrode fingers and a plurality of substantially parallel coplanar second electrode fingers. The plurality of substantially parallel coplanar second electrode fingers are interdigitated with the plurality of substantially parallel coplanar first electrode fingers and are not coplanar with the plurality of substantially parallel coplanar first electrode fingers. A voltage tunable dielectric layer may be interposed between the plurality of substantially parallel coplanar first electrode fingers and the plurality of substantially parallel coplanar second electrode fingers. The voltage tunable dielectric layer may be a BST layer, or any other voltage tunable dielectric layer.

### CROSS REFERENCE TO RELATED APPLICATIONS

This application claims the benefit of U.S. Provisional Application Ser. No. 61/661,894 filed Jun. 20, 2012.

### BACKGROUND

The present application generally relates to microwave devices and more particularly to high voltage varactors having a non-coplanar interdigitated structure.

High K tunable, microwave dielectrics such as Barium Strontium Titanate, BaₓSr₍₁₋₈)TiO₃ (BST), are gaining acceptance in microwave integrated circuits due to a large need for tunable/reconfigurable circuits. Semiconductor varactor diodes and PIN diodes can have relatively large Q (quality factor) below 10 GHz, but the Q can drop down drastically above 10 GHz making them less attractive for applications above 10 GHz. Radio-frequency (RF) microelectromechanical system (MEMS) switches can offer high Q at microwave and millimeterwave frequencies, but can be complex in nature, and the slow speed of switching can be undesirable for many applications. Ferroelectric varactors can be characterized by fast switching speed, ease of integration with silicon (Si) monolithic microwave integrated circuits (MMICs), and can have reasonable Q at microwave and millimeter-wave frequencies.

Variable capacitors are called as varactors. Typically varactors are semiconductor diodes operating under a reverse bias. Another variant of the varactor is a metal-insulator-metal capacitor (MIM), where the insulator material is a voltage tunable dielectric thin film. Thin film varactors are also implemented as either a parallel plate type or an inter-digitated capacitor (IDC) type. Parallel plate type are widely used in integrated circuit design as direct current (DC) blocks, or coupling capacitors. IDCs use a coplanar interdigitated architecture fabricated on a tunable dielectric layer such as a BST thin film. IDCs are widely used in integrated circuit design as direct current (DC) blocks, or coupling capacitors. IDCs use a coplanar interdigitated architecture fabricated on a tunable dielectric layer such as a BST thin film. IDCs do not provide a large tuning ratio (not more than 35%) with DC bias and can handle a high DC bias voltage (greater than 100 volts). The parallel plate varactors on the other hand has high tunability but cannot support a large DC bias voltage greater than 25 Volts. Furthermore, applying a high power RF signal to the parallel plate varactor affects the capacitance of the tunable dielectric layer because the RF signal induces a RF fringe field within the device which affects the applied DC bias voltage used to control the capacitance of the device. Therefore, it is often difficult to precisely control the capacitance of the parallel plate varactor with a DC bias voltage.

Therefore there is a need for a varactor to provide a large tuning ratio, a high DC biasing capability, and an ability to reduce the effects of the RF fringe field.

### SUMMARY

In one embodiment, an apparatus for a non-coplanar interdigitated structure may include a stacked structure having a plurality of substantially parallel coplanar first electrode fingers and a plurality of substantially parallel coplanar second electrode fingers interdigitated with the plurality of substantially parallel coplanar first electrode fingers and not coplanar with the plurality of substantially parallel coplanar first electrode fingers. A voltage tunable dielectric layer may be interposed between the plurality of substantially parallel coplanar first electrode fingers and the plurality of substantially parallel coplanar second electrode fingers.

In another embodiment, an apparatus for a high voltage varactor may include a stacked structure having an anode layer; a cathode layer; and a voltage tunable dielectric layer interposed between the anode layer and the cathode layer. The anode layer may include a plurality of substantially parallel coplanar first electrode fingers and the plurality of substantially first electrode fingers are coplanar and electrically coupled together. The cathode layer may include a plurality of substantially parallel coplanar second electrode fingers and the plurality of substantially parallel coplanar second electrode fingers are coplanar and electrically coupled together. The plurality of substantially parallel coplanar first electrode fingers and the plurality of substantially parallel coplanar second electrode fingers define a non-coplanar interdigitated structure.

These and additional features provided by the embodiments described herein will be more fully understood in view of the following detailed description, in conjunction with the drawings.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 depicts a top view of a non-coplanar interdigitated structure according to one or more embodiments described herein;

FIGS. 2A and 2B depict a cross-sectional view of the non-coplanar interdigitated structure according to one or more embodiments described herein;

FIG. 3 illustrates a schematic of the non-coplanar interdigitated structure according to one or more embodiments described herein;

FIG. 4 depicts a stacked structure of a high voltage varactor according to one or more embodiments described herein;

FIG. 5 depicts a top view of the high voltage varactor according to one or more embodiments described herein;

FIG. 6 depicts a cross section of the high voltage varactor according to one or more embodiments described herein;

FIGS. 7A and 7B depict a non-coplanar shunt interdigitated structure;

FIG. 8 illustrates a graph of the ratio of output power to the input power (S21) in decibels (dB) of the high voltage varactor;

FIG. 9 illustrates a graph of the S21 and the ratio of the reflected output power to the input power (S11) in dB of the non-coplanar shunt interdigitated structure at 0 volts; and

FIG. 10 illustrates a graph of the S21 and the S11 in dB of the non-coplanar shunt interdigitated structure at 180 volts.

### DETAILED DESCRIPTION

Before turning to the figures, which illustrate several embodiments in detail, it should be understood that the application is not limited to the details or methodology set forth in the description or illustrated in the figures. It should also be understood that the terminology is for the purpose of description only and should not be regarded as limiting. Whenever possible, the same reference numerals will be used throughout the drawing to refer to the same or like parts.

The present disclosure combines parallel plate architectures and interdigitated architectures to create a high voltage varactor that may provide a large tuning ratio (>35%) and a high DC bias voltage threshold capability (>100 volts to about 600 volts). Furthermore, the high DC bias threshold capability may allow for a high RF power handling capability where the resulting fringe electric field will not affect the capacitance of the high voltage varactor. The high voltage varactor combines these two architectures by having the first electrode reside on a first plane (an upper plate of a parallel plate architecture) and the second electrode reside on a second plane (a lower plate of the parallel plate architecture) separated from the first plane by a voltage tunable dielectric layer.

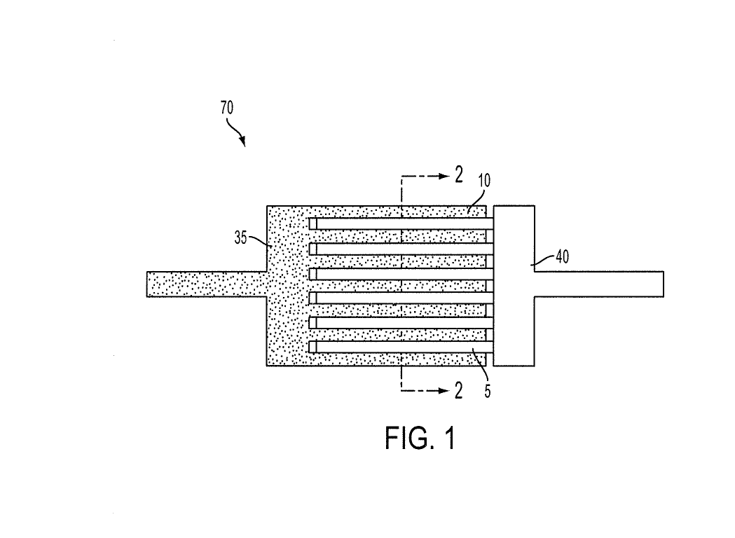

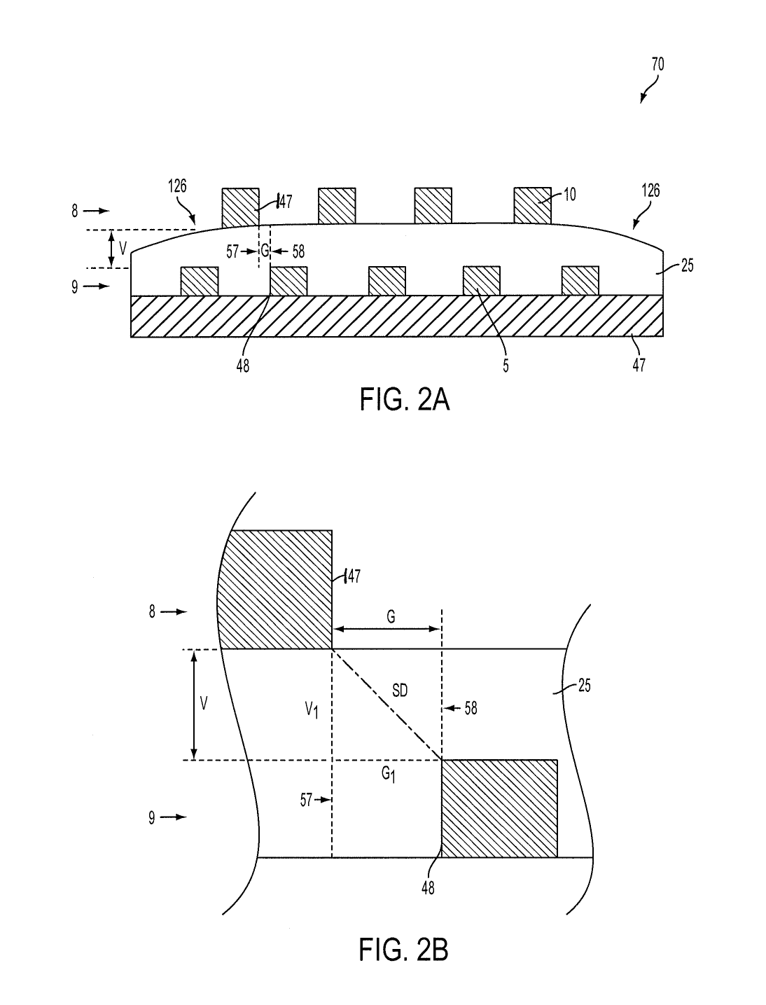

Referring to FIGS. 1, 2A, and 2B, a non-coplanar interdigitated structure 70 is shown. FIG. 1 is a top view of the non-coplanar interdigitated structure 70 and FIGS. 2A and 2B are a cross-sectional view of the non-coplanar interdigitated structure 70. On a first plane 8 are a plurality of substantially parallel coplanar first electrode fingers 10 that are substantially parallel to each other and are coplanar. On a second plane 9 are a plurality of substantially parallel coplanar second electrode fingers 5 that are substantially parallel to each other and are coplanar. The plurality of substantially parallel coplanar second electrode fingers 5 are not coplanar with the plurality of substantially parallel coplanar first electrode fingers 10. A voltage tunable dielectric layer 25 may be interposed between the first plane 8 and the second plane 9. A first terminal 35 is coplanar with and electrically coupled to the plurality of substantially parallel coplanar first electrode fingers 10. A second terminal 40 is coplanar with and electrically coupled to the plurality of substantially parallel coplanar second electrode fingers 5. When interconnecting the non-coplanar interdigitated structure 70 to external devices, the first terminal 35 and the second terminal 40 may electrically couple the non-coplanar interdigitated structure 70 to external circuits, electrical components, and the like. The plurality of substantially parallel coplanar first electrode fingers 10 and the plurality of substantially parallel coplanar second electrode fingers 5 are not limited in the number of substantially parallel fingers each electrode may have and the figures should not be construed as limited the number of substantially parallel fingers shown. For example, the plurality of substantially parallel coplanar first electrode fingers 10 and the plurality of substantially parallel coplanar second electrode fingers 5 may include 10, 20, 50, 100, or even more than 100 substantially parallel fingers and, likewise, may include fewer fingers than shown in the figures.

The voltage tunable dielectric layer 25 is a DC voltage tunable dielectric material and in exemplary embodiments may be a BST nanostructured thin film. As used herein the term “nanostructured” means having a grain size of less than 100 nm. Thus, in some embodiments the BST nanostructured thin film may have a grain size of less than 100 nm. In another embodiment, the voltage tunable dielectric layer 25 is a BST nanostructured thin film having an average grain size of approximately 30 nm to approximately 100 nm. Preferably, the voltage tunable dielectric layer 25 comprising the BST nanostructured thin film may have a thickness of about 0.1 μm to about 10 μm. In other embodiments, the voltage tunable dielectric layer may be selected from Strontium Titanate (STO), Magnesium (Mg), Manganese (Mn), Zinc (Zn), etc.

A vertical separation V is depicted in FIG. 2A. The vertical separation is a distance measured between a lower edge 11 of the plurality of substantially parallel coplanar first electrode fingers 10 in the first plane 8 and an upper edge 12 of plurality of substantially parallel coplanar second electrode fingers 5 in the second plane 9. In one embodiment, the vertical separation V may be a thickness of the voltage tunable dielectric layer 25. In another embodiment, the vertical separation V may include the thickness of the voltage tunable dielectric layer 25 plus the thickness of at least one additional material or layer (not shown) interposed between the first plane 8 and the second plane 9. For example, at least one additional material or layer may be disposed between the first plane 8 and the voltage tunable dielectric layer 25, between the second plane 9 and the voltage tunable dielectric layer 25, or both.

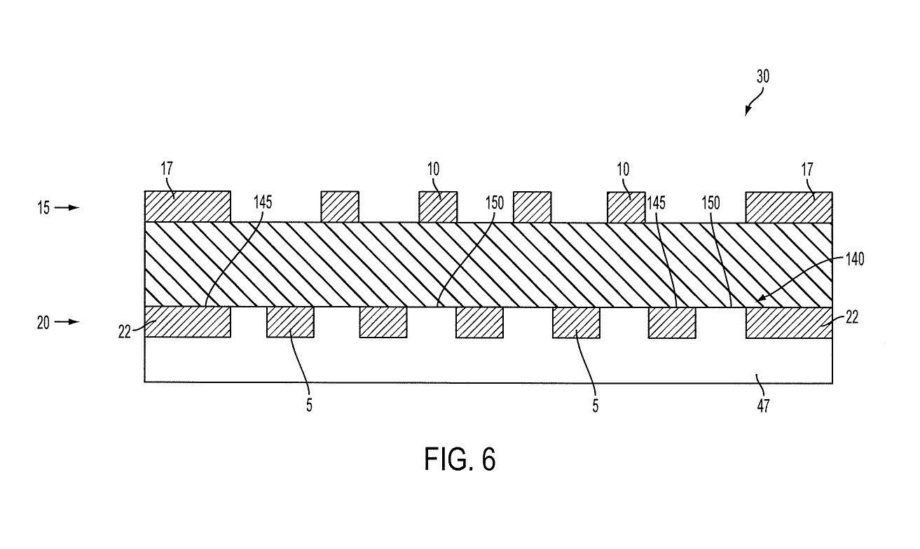

Referring still to FIG. 2A, the non-coplanar interdigitated structure 70 may have a foundation layer 47 such as, for example a sapphire wafer or a silicon wafer. The second plane 9 may be deposited on the foundation layer 47 and the voltage tunable dielectric layer 25 may be deposited over both the foundation layer 47 and the second plane 9. The voltage tunable dielectric layer 25 is shown with rounded corners 126 in FIG. 2A to illustrate variances in manufacturing only. It should not be construed that the voltage tunable dielectric layer 25 is required to have rounded corners 126. Finally, the first plane 8 may be deposited on the voltage tunable dielectric layer 25. The first plane 8 may be exposed to the atmosphere or it may have a protective layer (not shown) deposited over it. Referring to FIG. 6, in another embodiment, the foundation layer 47 may be a silicone material. The silicone material may be etched to allow the second plane 9 to be deposited within the foundation layer 47.

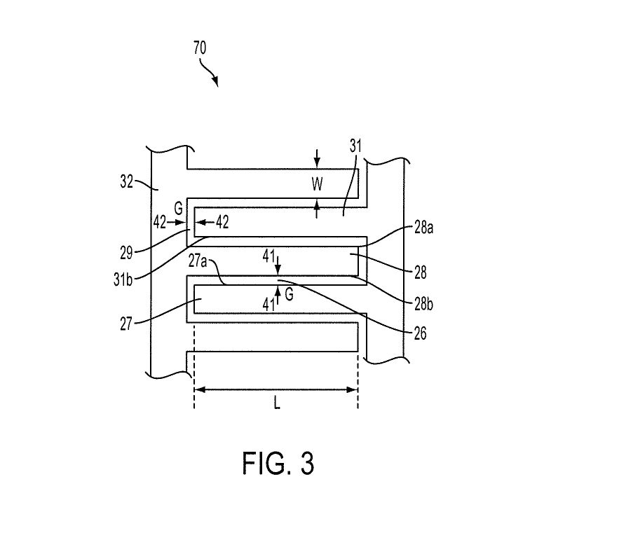

Referring to the non-coplanar interdigitated structure 70 of FIG. 1 and also to a schematic of the non-coplanar interdigitated structure 70 in FIG. 3, the architecture and the dimensions of the plurality of substantially parallel coplanar first electrode fingers 10 and the plurality of substantially parallel coplanar second electrode fingers 5 that affect the characteristics of the non-coplanar interdigitated structure 70 are shown. The plurality of substantially parallel coplanar first electrode fingers 10 have no vertical overlap with the plurality of substantially parallel coplanar second electrode fingers 5. For example, there may be a gap G between the plurality of substantially parallel coplanar first electrode fingers and the plurality of substantially parallel coplanar second electrode fingers 5. The gap G is measured as a lateral distance between a first finger 27 and a second finger 28 as viewed along a perpendicular axis to the first plane 8. The gap G is a uniform distance between all parallel points of the plurality of substantially parallel coplanar first electrode fingers 10 and the plurality of substantially parallel coplanar second electrode fingers 5 along a length L and a width W. For example, referring to a length gap region 26, the parallel, opposing edges of the first finger 27 and the second finger 28 at the tips of the arrows 41 is the gap G and is a uniform gap G distance along the length L of the plurality of substantially parallel coplanar first electrode fingers and the plurality of substantially parallel coplanar second electrode fingers 5. Likewise, a width gap region 29 is the parallel, opposing edges of a third finger 31 and a first terminal 32 at the tips of the arrows 42 and is a uniformed gap G distance along the width W of the plurality of substantially parallel coplanar first electrode fingers and the plurality of substantially parallel coplanar second electrode fingers. It should be noted that the terminology “uniform” distance may include an average distance to account for variation in tolerances of the edges during manufacturing and degradation of the non-coplanar interdigitated structure 70 during operation. It should also be apparent that the first finger 27, second finger 28, and the third finger 31 are representative of the plurality of substantially parallel coplanar first electrode fingers and the plurality of substantially parallel coplanar second electrode fingers 5 and should not be construed as limiting the quantity of fingers.

As shown in FIG. 3, the length L is defined as an edge of one of the first finger (e.g. 27a) and an edge of the second finger (e.g. 28b) adjacent to the edge of the first finger (e.g. 27a). Continuing the illustration of the length L is defined as an edge of the second finger (e.g. 28a) and an edge of the third finger (e.g. 31b) adjacent to the edge of the second finger (e.g. 28a). The width W is represented by the width of an individual finger (for example first finger 28). The gap G is a two dimensional construct best illustrated by the horizontal views of FIGS. 1 and 3 in the context of the cross-section of FIGS. 2A and 2B. In some embodiments, the gap G may be greater than zero. Referring to FIGS. 2A and 2B, vertically in the third dimension, the gap G is measured between a first opposing edge 47 with a first perpendicular axis 57 and a second opposing edge 48 with a second perpendicular axis 58. In other embodiments, the gap G may equal zero. Without intent to be bound by theory, it is believed that the first perpendicular axis 57 and the second perpendicular axis 58 may include the embodiment where they are the same axis and the plurality of substantially parallel coplanar first electrode fingers 10 and the plurality of substantially parallel coplanar second electrode fingers 5 and nevertheless have no vertical overlap. Furthermore, it is believed that if vertical overlap were to occur, as for example between the first opposing edge 47 and the second opposing edge 48, a parallel plate capacitor structure would result within an overlapping region, and the performance of the non-coplanar interdigitated structure 70 would be diminished.

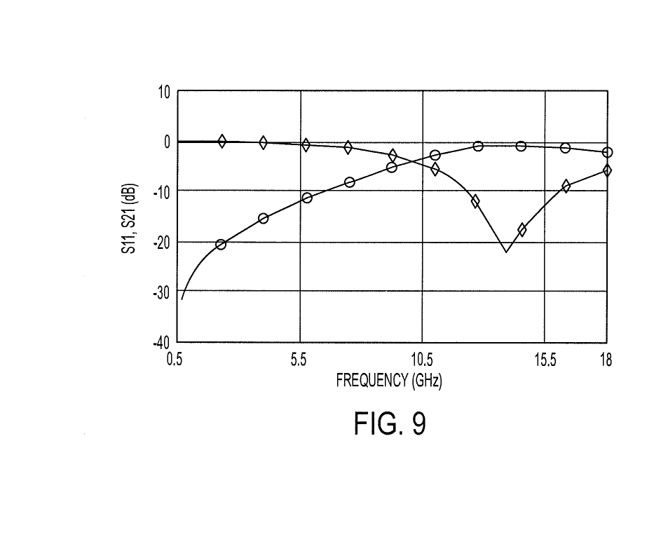

FIG. 2B illustrates a separation distance SD between the first opposing edge 47 and the second opposing edge 48. The separation distance SD is the hypotenuse of the triangle formed by the vertical separation V1 and the gap G1 dimensions between the between the first opposing edge 47 and the second opposing edge 48. The separation distance SD enables the electric field between the plurality of substantially parallel coplanar first electrode fingers 10 and the plurality of substantially parallel coplanar second electrode fingers 5 to be constrained within the voltage tunable dielectric layer 25. The larger the separation distance SD is, the larger the DC bias threshold becomes. This relationship is further described below with reference to FIG. 9.

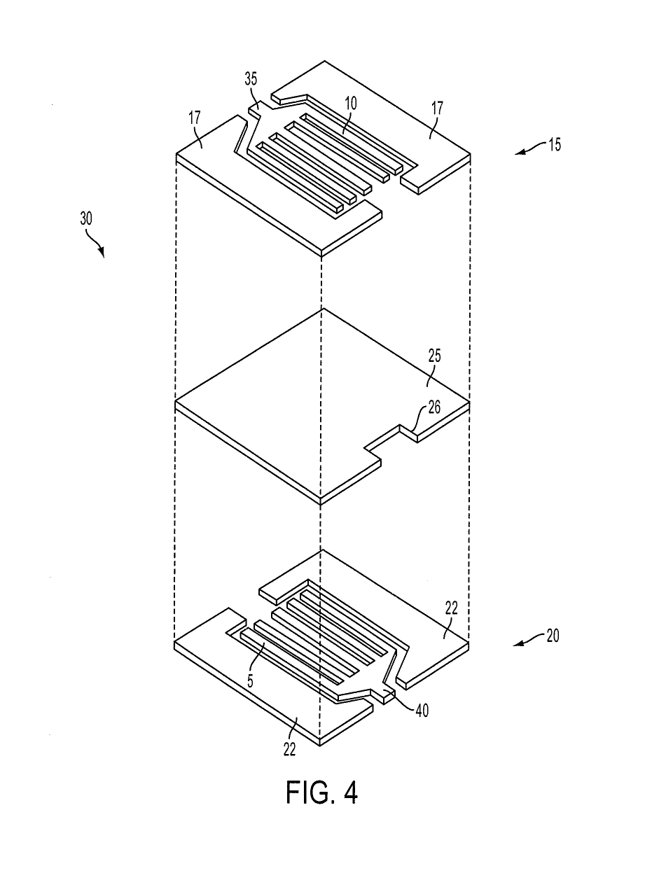

Referring to FIGS. 4-6, a stacked structure of a high voltage varactor 30 is shown. The high voltage varactor 30 may include an anode layer 15 and a cathode layer 20, separated by the voltage tunable dielectric layer 25. The voltage tunable dielectric layer 25 may be interposed between the anode layer 15 and the cathode layer 20. Although in the embodiment of FIG. 4, the voltage tunable dielectric layer 25 shown between the anode layer 15 and the cathode layer 20, in other embodiments, one or more additional layers may also be included between the anode layer 15 and the voltage tunable dielectric layer 25 and/or between the voltage tunable dielectric layer 25 and the cathode layer 20. The anode layer 15 may include the plurality of substantially parallel coplanar first electrode fingers 10 coplanar with the first terminal 35. The cathode layer 20 may include the plurality of substantially parallel coplanar second electrode fingers 5 coplanar with the second terminal 40. The anode layer 15 and the cathode layer 20 may be made from metal or other material that conducts electricity, such as a doped substrate for example.

A first ground plane 17 may be coplanar with the anode layer 15 and may be electrically coupled to ground. The first ground plane 17 may be electrically isolated from the plurality of substantially parallel coplanar first electrode fingers 10 and the first terminal 35. A second ground plane 22 may be coplanar with the cathode layer 20 and be electrically coupled to ground. The second ground plane 22 may be electrically isolated from the plurality of substantially parallel coplanar second electrode fingers 5 and the second terminal 40. The term “ground” is used to denote a reference point from which other voltages within an electrical circuit are measured, or a common return path for electrical current, or a direct connection to earth. In some embodiments, the first ground plane 17 and the second ground plane 22 are electrically coupled together. In another embodiment, the first ground plane 17 and the second ground plane 22 are electrically isolated. A notch 26 may be removed from the voltage tunable dielectric layer 25 to allow for an electrical connection to be made to the second terminal 40 from an external circuit (not shown). The high voltage varactor 30 may be packaged as a microstrip structured device.

It should be understood that the terminology of “anode” and “cathode” are used for convenience only and are not limiting. “Anode” and “cathode” are not intended to import a direction of current flow through the non-coplanar interdigitated structure 70 or the high voltage varactor 30 but are used to denote electrical connections that may be used interchangeably. In some embodiments, the anode layer 15 may be the anode and the cathode layer 20 may be the cathode. In other embodiments, the anode layer 15 may be the cathode and the cathode layer 20 may be the anode.

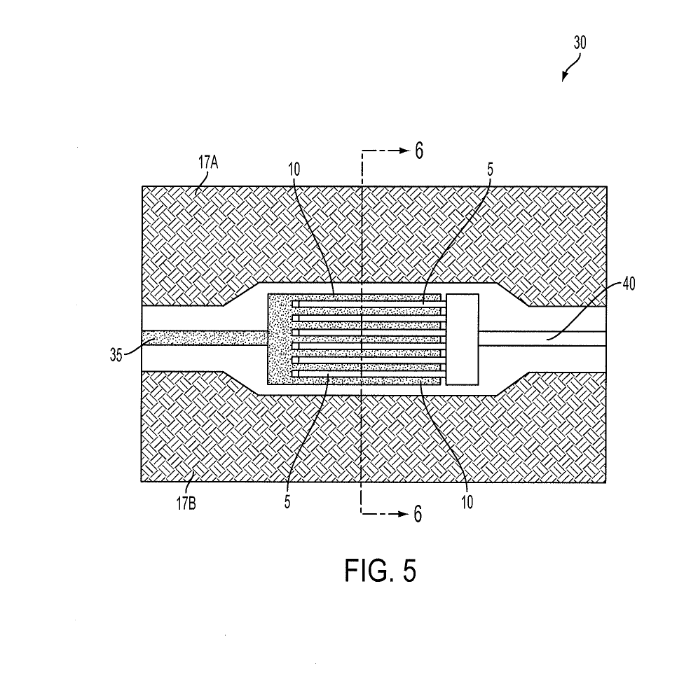

FIG. 5 is a top view of a high voltage varactor 30 including the non-coplanar interdigitated structure 70 of FIG. 1. As described above, the plurality of substantially parallel coplanar first electrode fingers 10 and the plurality of substantially parallel coplanar second electrode fingers 5 reside on the anode layer 15 and the cathode layer (not shown in FIG. 5) respectively. The voltage tunable dielectric layer 25 is shown as transparent in FIG. 5 to illustrate the interdigitated configuration of the high voltage varactor 30. The first ground plane 17 surrounds the plurality of substantially parallel coplanar first electrode fingers 10 in two sections, 17A and 17B. Both sections 17A and 17B may be electrically coupled together.

FIG. 6 illustrates the non-coplanar structure of the high voltage varactor 30. The anode layer 15 includes the first ground plane 17, the first terminal 35 (not shown), and the plurality of substantially parallel coplanar first electrode fingers 10, all of which are coplanar. The cathode layer 20 includes the second ground plane 22, the second terminal 40, and the plurality of substantially parallel coplanar second electrode fingers 5. In this embodiment, the cathode layer 20 may be embedded into the foundation layer 47. For example, if the foundation layer 47 is a silicone material, the silicone material may be etched to allow the cathode layer 20 to be deposited within the foundation layer 47. A top surface 140 may be polished smooth so a top portion 145 of the plurality of substantially parallel coplanar second electrode fingers 5 is coplanar with a top portion 150 of the foundation layer 47. In another embodiment, and referring to FIG. 2A, the cathode layer 20 may be deposited on top of the foundation layer 47.

Referring to FIGS. 2, 3, and 6, the characteristics of the non-coplanar interdigitated structure 70 and the high voltage varactor 30 may be optimized for a specific application through selection of a set of dimensions (the vertical separation V, the gap G, the length L, and the width W) of the non-coplanar interdigitated structure 70 of the high voltage varactor 30. The set of dimensions may be selected during the design of the high voltage varactor 30 to change a capacitance and a DC biasing voltage threshold. Without intent to be bound by theory, it is believed that increasing the vertical separation V and/or the gap G between the plurality of substantially parallel coplanar first electrode fingers 10 of the anode layer 15 and the plurality of substantially parallel coplanar second electrode fingers 5 of the cathode layer 20, may increase the capacitance and the DC biasing threshold of the high voltage varactor 30. An increase in the vertical separation V may in turn decrease the effect of a fringe electric field between the plurality of substantially parallel coplanar first electrode fingers 10 and the plurality of substantially parallel coplanar second electrode fingers 5. During operation of the high voltage varactor 30, the fringe electric field is produced within the high voltage varactor 30 by an RF signal applied to either the first terminal 35 or the second terminal 40. One consequence of a reduced fringe electric field effect due to increase vertical separation is that a higher bias voltage (e.g. greater than 100 volts) potential is required to start tuning the BST in the voltage tunable dielectric layer 25. This characteristic may allow the high voltage varactor 30 to have larger magnitude DC bias voltage threshold capability. Specifically, the high voltage varactor 30 according to some embodiments may be able to handle a DC bias voltage in the range of about 0 volts DC to about 600 volts DC.

The voltage tunable dielectric layer 25 may be made of any dielectric material having properties that depend upon a voltage applied across a layer of the dielectric material. For example, the voltage tunable dielectric layer 25 may be selected from Strontium Titanate (STO), Magnesium (Mg), Manganese (Mn), Zinc (Zn), etc. In one embodiment, the voltage tunable dielectric layer 25 may be a BST layer. The capacitance of the non-coplanar interdigitated structure 70 may be varied during operation of the high voltage varactor 30 by applying a DC bias voltage to the BST. The increase in the vertical separation V and the resulting reduced effect of the fringe electric field will help to insulate the fringe electric field from affecting, or inducing a voltage upon, the DC bias voltage. By insulating the DC bias voltage from the fringe electric field, the capacitance of the high voltage varactor 30 may be more precisely controlled.

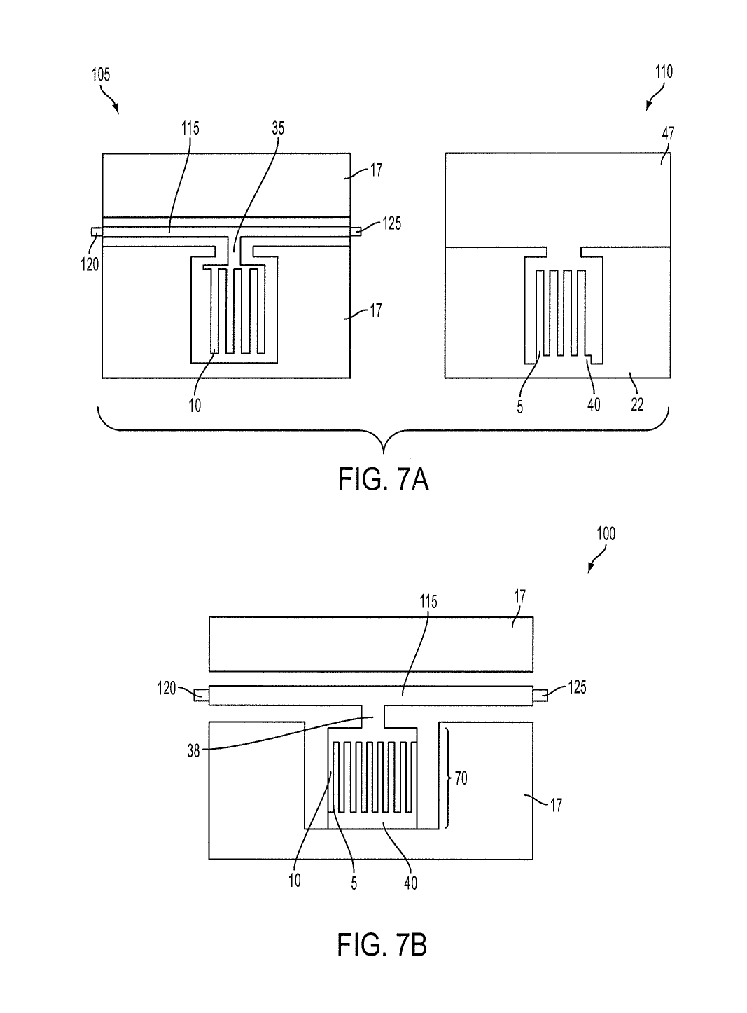

FIGS. 7A and 7B depict a non-coplanar shunt interdigitated structure 100. A top layer 105 includes the first ground plane 17, the first terminal 35, the plurality of substantially parallel coplanar first electrode fingers 10, a transmission line 115, a first port 120 coupled to a first end of the transmission line 115, and a second port 125 coupled to a second end of the transmission line 115, all of which are coplanar with each other. The first end and the second end are at opposite ends of the transmission line 115. A bottom layer 110 includes the plurality of substantially parallel coplanar second electrode fingers 5, the second ground plane 22, and the second terminal 40, all of which are coplanar with each other. The top layer 105 is not coplanar with the bottom layer 110. The bottom layer 110 may reside on or in the foundation layer 47 as described above.

The non-coplanar shunt interdigitated structure 100 is a stacked structure with the voltage tunable dielectric layer 25 (not shown) interposed between the top layer 105 and the bottom layer 110. The stack structure of the non-coplanar shunt interdigitated structure 100 mimics the stacked structure of the high voltage varactor 30 in FIG. 4. In other embodiments, one or more additional layers (not shown) may also be included between the top layer 105 and the voltage tunable dielectric layer 25 and/or between the voltage tunable dielectric layer 25 and the bottom layer 110. The non-coplanar interdigitated structure 70 is evident in FIG. 7B. As described above, the plurality of substantially parallel coplanar first electrode fingers 10 have no vertical overlap with the plurality of substantially parallel coplanar second electrode fingers 5. The second terminal 40 may be electrically coupled to the second ground plane 22 and to the plurality of substantially parallel coplanar second electrode fingers 5. The second ground plane 22 may be electrically coupled to ground. The first terminal 35 may be electrically coupled to the plurality of substantially parallel coplanar first electrode fingers 10 and the transmission line 115. The transmission line 115 may be a conductor or conductors designed to carry electricity or an electric signal with minimal loss or distortion. The transmission line 115 may be electrically coupled to the first port 120 and the second port 125. The first port 120 and the second port 125 may be used to electrically couple external circuits, test equipment, or equipment that transmit and receive electrical signals.

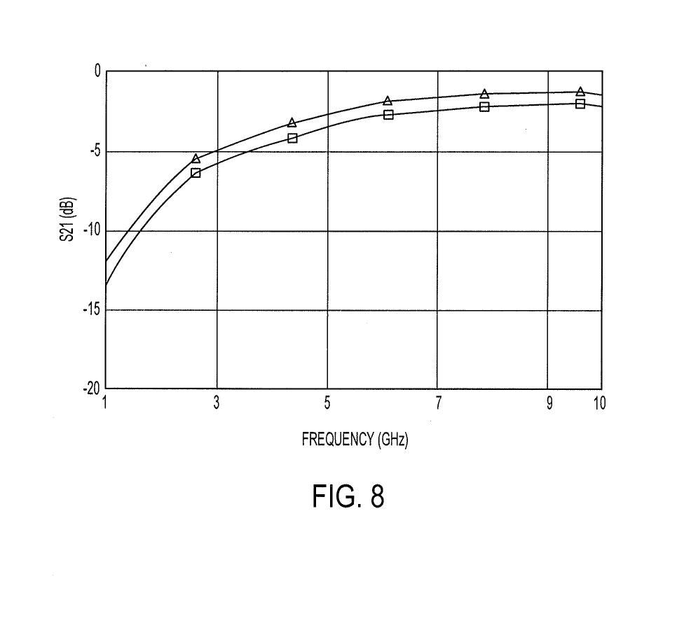

FIG. 8 illustrates a graph of the ratio of the transmitted output power to the input power (S21) in decibels (dB) of the high voltage varactor. The gap G of the non-coplanar interdigitated structure is 4 micrometers. The first plot represents the DC biasing voltage at 0 volts (triangle). The second plot represents the DC biasing voltage at 200 volts (square). The 0 volt (triangle) plot and the 200 volt (square) plot illustrate a relationship that as the DC biasing voltage is increased, the output power of the non-coplanar interdigitated structure decreases. As the DC bias voltage increases, the capacitance of the voltage tunable dielectric layer in the stacked structure of the non-coplanar interdigitated structure decreases. By reducing the capacitance of the non-coplanar interdigitated structure, the RF signal transmitted to the output port (either the first terminal or the second terminal) is reduced.

FIG. 9 illustrates a graph of the S21 and the ratio of the reflected output power to the input power (S11) in dB of the non-coplanar shunt interdigitated structure at 0 volts. The gap G of the non-coplanar shunt interdigitated structure is 7 micrometers and the DC biasing voltage is 0 volts. A 0 volt S21 (circle) plot and a 0 volt S11 (diamond) plot are shown. Referring to the 0 volt S11 (circle) plot, a resonance around 13 GHz is shown. The resonance is caused by the non-coplanar shunt interdigitated structure's capacitance between adjacent fingers across the separation distance SD in series with the inductance of each finger along the length L in the non-coplanar interdigitated structure.

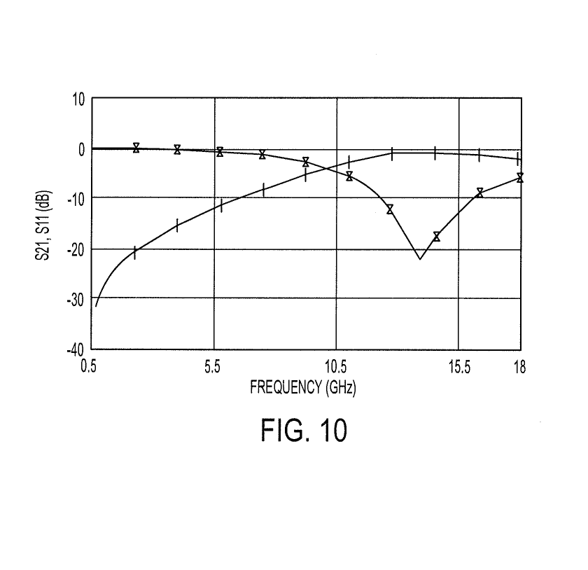

FIG. 10 illustrates a graph of the S21 and the S11 in dB of the non-coplanar shunt interdigitated structure at 180 volts. The gap G of the non-coplanar shunt interdigitated structure is 7 micrometers and the DC biasing voltage is 180 volts. A S11 (vertical line) plot and a S21 (hourglass) plot are shown for the applied DC voltage of 180 V. Referring to the 180 volt S21 (hourglass) plot, the resonance frequency has shifted to 15 GHz when compared to the 13 GHZ of the 0 volt S11 (vertical line) from FIG. 9 as explained below.

FIGS. 10 and 11 illustrate together that, as the DC bias voltage increases, the capacitance of the voltage tunable dielectric layer decreases, resulting in shifting the resonance frequency to a higher frequency. This is advantageous to stop an electric signal from being transmitted on the transmission line 115 of FIG. 7 if the electric signal is oscillating at the resonant frequency. For example, an electric signal oscillating at 15 GHz would able to be transmitted along the transmission line 115 between the first port 120 and the second port 125 when the DC biasing voltage is about 0 volts. When the DC biasing voltage is increased, the resonance frequency of the non-coplanar shunt interdigitated structure increases as the capacitance of the voltage tunable dielectric layer decreases, thereby starting and increasing the filtering of the 15 GHz signal. When the DC biasing voltage reaches 180 volts, the 15 GHz signal will be completely filtered from the transmission line 115. In other words, the 15 GHz signal will not be allowed to be transmitted between the first port 120 and the second port 125.

The resonance frequency range described above is exemplary only and should not be considered limiting on the structure or properties of high voltage varactors according to embodiments herein. For example, DC biasing voltage may be as high as 600 volts, thereby shifting the resonance frequency higher into the GHz frequency range. Furthermore, it has been found that as the gap G increases, the resonance frequency of the non-coplanar shunt interdigitated structure decreases. The decrease in the resonance frequency correlates to a decrease in the required DC biasing voltage and an increase in the capacitance of the voltage tunable dielectric layer.

In some embodiments of high voltage varactors, the gap G may be from about 0 micrometers to about 20 micrometers and more preferably from about 2 micrometers to about 8 micrometers. The voltage tunable dielectric layer may have a tuning ratio of about 33% in the non-coplanar interdigitated structure and the non-coplanar shunt interdigitated structure may have a tuning ratio of about 40%.

As explained above, the resonance is caused by the non-coplanar shunt interdigitated structure's capacitance between the plurality of substantially parallel coplanar first electrode fingers and the plurality of substantially parallel coplanar second electrode fingers across the separation distance SD in series with the inductance of each finger of the plurality of substantially parallel coplanar first electrode fingers and the plurality of substantially parallel coplanar second electrode fingers along the length L. The number of fingers in the plurality of substantially parallel coplanar first electrode fingers and the plurality of substantially parallel coplanar second electrode fingers affect the capacitance between plurality of substantially parallel coplanar first electrode fingers and the plurality of substantially parallel coplanar second electrode fingers across the separation distance SD and the inductance of each finger of the plurality of substantially parallel coplanar first electrode fingers and the plurality of substantially parallel coplanar second electrode fingers along the length L. For example, the capacitance increases as the number of fingers in each plurality of substantially parallel coplanar first electrode fingers and the plurality of substantially parallel coplanar second electrode fingers increases. The inductance in each finger of the plurality of substantially parallel coplanar first electrode fingers and the plurality of substantially parallel coplanar second electrode fingers decreases as the number of fingers in the plurality of substantially parallel coplanar first electrode fingers and the plurality of substantially parallel coplanar second electrode fingers increases.

It is noted that the terms “substantially” and “about” may be used herein to represent the inherent degree of uncertainty that may be attributed to any quantitative comparison, value, measurement, or other representation. These terms are also used herein to represent the degree by which a quantitative representation may vary from a stated reference without resulting in a change in the basic function of the subject matter at issue.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Certain terminology is used in the disclosure for convenience only and is not limiting. The words “left”, “right”, “front”, “back”, “top”, “bottom”, “upper”, “lower”, “vertical”, and “horizontal” designate directions in the drawings to which reference is made. The terminology includes the words noted above as well as derivatives thereof and words of similar import.

While the present disclosure has been particularly shown and described with reference to specific embodiments, it should be understood by those skilled in the art that various changes in form and detail may be made therein without departing from the spirit and scope of the disclosure as defined by the appended claims.

What is claimed is:

1. A non-coplanar interdigitated structure, comprising:
a stacked structure having:
a plurality of substantially parallel coplanar first electrode fingers;
a plurality of substantially parallel coplanar second electrode fingers interdigitated with the plurality of substantially parallel coplanar first electrode fingers are not coplanar with the plurality of substantially parallel coplanar first electrode fingers; and
a voltage tunable dielectric layer interposed between the plurality of substantially parallel coplanar first electrode fingers and the plurality of substantially parallel coplanar second electrode fingers.

2. The non-coplanar interdigitated structure of claim 1, wherein the plurality of substantially parallel coplanar first electrode fingers have no vertical overlap with the plurality of substantially parallel coplanar second electrode fingers.

3. The non-coplanar interdigitated structure of claim 1, further comprising:
a first terminal coplanar with and electrically coupled to the plurality of substantially parallel coplanar first electrode fingers; and
a second terminal coplanar with and electrically coupled to the plurality of substantially parallel coplanar second electrode fingers.

4. The non-coplanar interdigitated structure of claim 3, wherein the first terminal and the plurality of substantially parallel coplanar first electrode fingers have no vertical overlap with the second terminal and the plurality of substantially parallel coplanar second electrode fingers.

5. The non-coplanar interdigitated structure of claim 3, wherein the first terminal is electrically coupled to a transmission line comprising a first port electrically coupled to the transmission line at a first end and a second port electrically coupled to the transmission line at a second end, wherein the first end and the second end are at opposing ends of the transmission line, and the transmission line is coplanar with the first terminal.

6. The non-coplanar interdigitated structure of claim 1, wherein the voltage tunable dielectric layer is a barium strontium titanate nanostructured thin film.

7. A high voltage varactor comprising a stacked structure having an anode layer; a cathode layer;
and a voltage tunable dielectric layer interposed between the anode layer and the cathode layer, wherein:
the anode layer comprises a plurality of substantially parallel coplanar first electrode fingers,
the plurality of substantially parallel coplanar first electrode fingers are coplanar and electrically coupled together,
the cathode layer comprises a plurality of substantially parallel coplanar second electrode fingers,
the plurality of substantially parallel coplanar second electrode fingers are coplanar and electrically coupled together, and
the plurality of substantially parallel coplanar first electrode fingers and the plurality of substantially parallel coplanar second electrode fingers define a non-coplanar interdigitated structure.

8. The high voltage varactor of claim 7, wherein the plurality of substantially parallel coplanar first electrode fingers have no vertical overlap with the plurality of substantially parallel coplanar second electrode fingers.

9. The high voltage varactor of claim 7, further comprising:
a first terminal coplanar with the anode layer and electrically coupled to the plurality of substantially parallel coplanar first electrode fingers; and
a second terminal coplanar with the cathode layer and electrically coupled to the plurality of substantially parallel coplanar second electrode fingers.

10. The high voltage varactor of claim 9, wherein the first terminal and the plurality of substantially parallel coplanar first electrode fingers have no vertical overlap with the second terminal and the plurality of substantially parallel coplanar second electrode fingers.

11. The high voltage varactor of claim 10, wherein the first terminal is electrically coupled to a transmission line comprising a first port electrically coupled to the transmission line at a first end and a second port electrically coupled to the transmission line at a second end, wherein the first end and the second end are at opposing ends of the transmission line, and the transmission line is coplanar with the first terminal.

12. The high voltage varactor of claim 7, wherein the high voltage varactor is packaged as a microstrip structured device.

13. The high voltage varactor of claim 7, wherein the voltage tunable dielectric layer is a barium strontium titanate nanostructured thin film.

14. A non-coplanar shunt interdigitated structure comprising:
a top layer comprising:
a first terminal,
a plurality of substantially parallel coplanar first electrode fingers electrically coupled to the first terminal,
a transmission line electrically coupled to the first terminal,
a first port electrically coupled to the transmission line at a first end, and
a second port electrically coupled to the transmission line at a second end wherein the first end and the second end are at opposing ends of the transmission line, and
the first terminal, the plurality of substantially parallel coplanar first electrode fingers, the transmission line, the first port, and the second port are all coplanar with each other;
a bottom layer comprising:
a second terminal,
a plurality of substantially parallel coplanar second electrode fingers electrically coupled to the second terminal,
a second ground plane electrically coupled to the second terminal wherein the second terminal, the plurality of substantially parallel coplanar second electrode fingers, and the second ground plane are all coplanar with each other; and
a stacked structure comprising the top layer, the bottom layer, and a voltage tunable dielectric layer interposed between the top layer and the bottom layer and wherein the top layer is not coplanar with the bottom layer.

15. The non-coplanar shunt interdigitated structure of claim 14, wherein the first terminal and the plurality of substantially parallel coplanar first electrode fingers have no vertical overlap with the second terminal and the plurality of substantially parallel coplanar second electrode fingers.

16. The non-coplanar shunt interdigitated structure of claim 14, wherein non-coplanar shunt interdigitated structure is packaged as a microstrip structured device.

17. The non-coplanar shunt interdigitated structure of claim 14, wherein the voltage tunable dielectric layer is a barium strontium titanate nanostructured thin film.
